(19) United States
(12) Patent Application Publication
(10) Pub. No.: US 2012/0043406 A1
(43) Pub. Date: Feb. 23, 2012

(54) DRIVE DEVICE FOR DRIVING A WORK UNIT

(75) Inventors: Markus Klotz, Hainau (DE); Dieter Brand, Dausenau (DE)

(73) Assignee: LEIFHEIT AG, Nassau (DE)

(21) Appl. No.: 13/262,324

(22) PCT Filed: Apr. 2, 2010
(86) PCT No.: PCT/DE2010/075031

§ 371 Date: Oct. 27, 2011

(30) Foreign Application Priority Data
Apr. 3, 2009 (DE) 10 2009 016 205.4

(51) Int. Cl. F16H 21/00; B01F 15/00; B02C 19/00

(52) U.S. Cl. 241/277; 74/25; 366/343

(57) ABSTRACT

The invention relates to a drive device (10) for driving a work unit (30), which contains grinding elements for food, for example, and a method for driving the work unit. The drive device (10) and the work unit (30) are implemented modularly, the work unit (30) being coupled using a coupling device (31) to a rotation transmission unit (18) of the drive device (10)

The invention relates to a drive device for driving a work unit and a method for driving a work unit.

Drive devices are known in manifold different types of embodiments and are used in manifold technical fields. Thus, using drive devices for driving grinding elements for foods in grinding devices and stirring elements for sauces in stirring devices is already known, for example.

A grinding device for food is known from WO2007/009654, in which a spindle is used as a drive device for driving grinding elements. A coupling device, which is connected to the grinding elements, is fixedly connected to the spindle in this grinding device. The spindle is partially housed and the grinding elements are completely housed inside a housing of the grinding device.

Such a connection of the drive device to the coupling device of the grinding elements has manifold disadvantages. Thus, because of the fixed connection of the coupling device to the drive device, it is not possible to use the drive device for other devices, such as stirring devices. I.e., every device must be provided with a separate drive device, which in turn increases the production costs of the respective device. A further disadvantage of such a connection is that the devices are relatively large, whereby the storage space required for the individual device is increased.

It is the object of the present invention to provide a drive device which can be used in a plurality of devices. A further object of the invention comprises ensuring that the size of the respective device is reduced.

These objects are achieved according to the invention by the features of Patent claim 1 or Patent claim 13, respectively. Advantageous embodiments of the invention are characterized in the subclaims.

The invention has the advantage that a coupling device of the work unit can be engaged with a rotation transmission unit of the drive device. It is thus possible for the drive device and the work unit to be implemented modularly as separate components. This allows the drive device to be able to be used to drive multiple different devices, each having different work units. A further advantage of such a modular implementation is that the size of the individual device decreases, since the devices no longer necessarily must have a drive unit. As a result, the total required storage space of the devices is also decreased, since these have a small size and the drive unit can be stored separately from the respective device. In addition, an advantage of the invention is that the production costs of the individual devices are decreased, since the devices can be produced without a drive device, for example.

In a further advantageous embodiment of the invention, by providing a partition unit between the drive device and the work unit, soiling of the drive device can be prevented. Therefore, only the work unit must still be cleaned after operation of the device.

Furthermore, in a further advantageous embodiment of the invention, using the coupling element of the drive device, the drive device can be fixed in a partition unit. The coupling element is implemented so that it can be inserted into a corresponding recess of the partition unit. A further advantage is that through the removable fastening of the coupling element on the drive device, a correspondingly shaped coupling element can be attached to the drive device depending on the shape of the recess of the partition unit. Therefore, the usage capability of the drive device is increased, since it can be inserted into differently shaped recesses using the partition element.

Details of the invention are explained in greater detail on the basis of the drawing, identically acting elements being provided with the same reference numerals. In the figures:

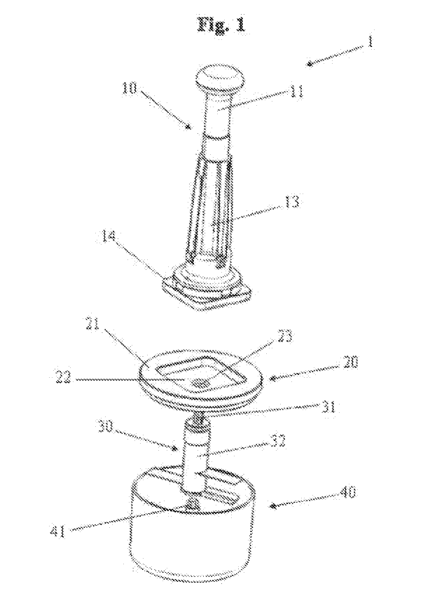

FIG. 1: shows an exploded view of a grinding device,

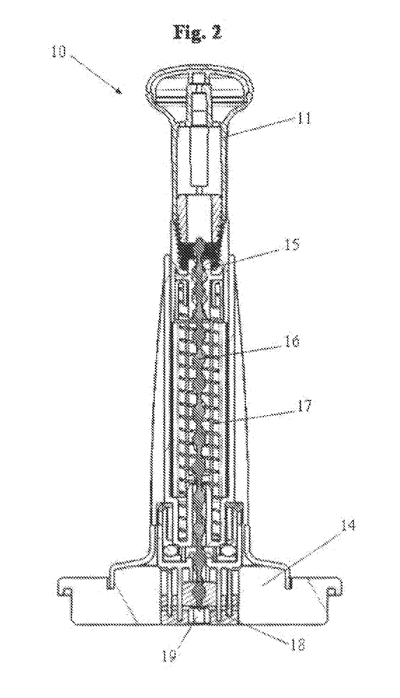

FIG. 2: shows a sectional view of a drive device,

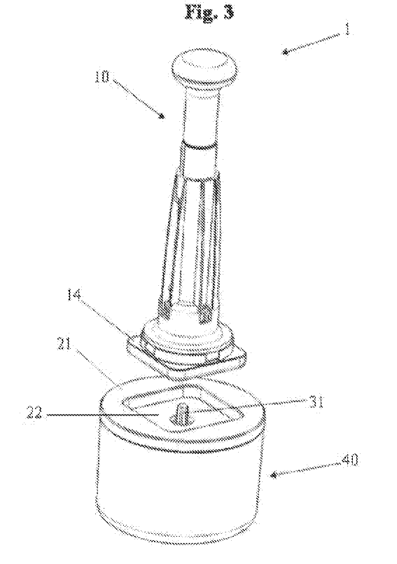

FIG. 3: shows the grinding device in a partially assembled state,

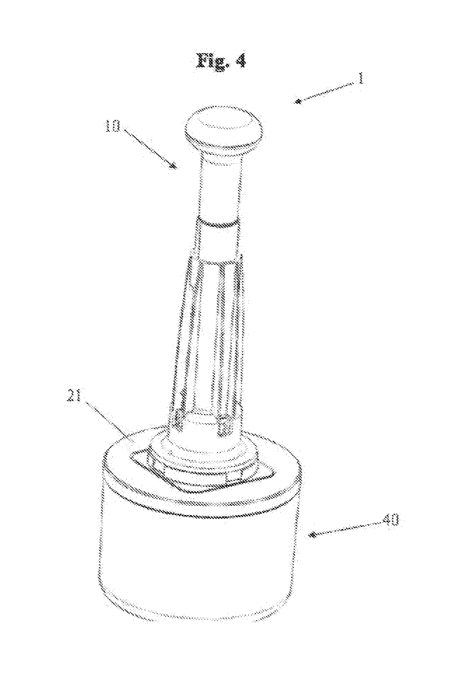

FIG. 4: shows the grinding device in the assembled state.

The grinding device 1, which is shown in an exploded view in FIG. 1, has a drive device 10, a partition unit 20, and a container 40. The drive device 10 has a rotationally-fixed actuating device 11, a coupling element 14, and a housing 13, which is situated between the actuating device 11 and the coupling element 14.

The actuating device 11 has a plunger shape and is displaceable along a longitudinal axis of the drive device 10. During a movement of the actuating device 11, it moves relative to the housing 13, which is not movable in the longitudinal direction. The coupling element 14 is removably connected to the housing 13.

The partition unit 20 has a partition element 21, which terminates the container 40. The partition element 21 has a recess 22, which has the same shape as the coupling element 14 of the drive device 10. The recess 22 has an opening 23, which is dimensioned in such a way that a coupling device 31 of a drive unit 30 can go through it.

In addition to the coupling device 31, the work unit 30 has a work element 32, which is connected to the coupling device 31. The coupling device 31 is implemented in this embodiment as a body having a polygonal shape, but can also have other shapes, The work element 32 is implemented in this case as a cylindrical body, on which grinding elements, which run transversely to its axis, are situated for grinding foods. The work elements 32 can be implemented as stirring elements, spinning elements, striking elements, and/or as other tool elements instead of the grinding elements, depending on the device. The work unit 30 has an opening for placing the work unit 30 on a mounting element 41 on the end remote from the coupling device 31. The mounting element 41 is connected to the container 40 and is used to fix the work unit 30. The container 40 is used to accommodate the foods, sauces, etc. to be processed and is implemented as cylindrical, other shapes also being conceivable.

FIG. 2 shows a sectional view of the drive device 10, in which the actuating device 11 is located in a maximally extended position. The drive device 10 is a spindle drive device 10 in this case. However, other drive devices are also conceivable, which have another drive unit 16 instead of a spindle 16. It is recognizable from FIG. 2 that the actuating device 11, the housing 13, and the coupling element 14 each form a cavity. The rotationally-fixed actuating device 11 is coupled to a rotationally-fixed rotation generation unit 15, which is implemented as a spindle nut 15 and is designated in such a way hereafter. The spindle nut 15 can be coupled to the spindle 16. More precisely, the spindle nut 15 can be coupled to a thread of the spindle 16. In this case, any possible embodiment which allows a conversion of a longitudinal movement into a rotational movement of the spindle 16 is understood as a thread. I.e., the thread is not to be limited to a screw thread, for example.

Inside the cavity of the housing 13, the spindle drive device 10 has a spring 17, which is connected at one end to the spindle nut 15. At the end remote from the spindle nut 15, the spring 17 is situated inside the spindle drive device 10 in such a way that it can be pre-tensioned in the direction toward the coupling element 14 during a movement of the spindle nut 15. In addition, the spindle drive device 10 has a locking device (not shown in FIG. 2). Using this locking device, during an actuation of the grinding device 1, the actuating device 11 can be locked in the actuated, compressed position and a movement of the actuating device 11 into the starting position can thus be prevented.

The spindle 16 extends over the respective cavities of the actuating device 11, the housing 13, and the coupling element 14. The spindle 16 is coupled on its end remote from the actuating device 11 to a rotation transmission unit 18. The rotation transmission unit 18 has a coupling opening 19 corresponding to the polygonal shape of the coupling device 31. Through such a shape of the coupling opening 19 of the rotation transmission unit 18, it is ensured that the rotational movement of the spindle 16 is transmitted via the rotation transmission unit 18 and the coupling device 31 to the work elements 32 when the coupling device 31 is engaged with the rotation transmission unit 18. Alternatively, the rotation transmission unit 18 can be situated in the partition unit 20. In this case, the rotation transmission unit 18 would be connected or coupled to the work unit 30 and would have a coupling for coupling to the spindle 16 on the end facing toward the spindle 16. The spindle 16 can have multiple sections each having different thread pitches. The number and implementation of the sections is a function of the requirements with respect to the torques to be delivered by the spindle 16 and/or with respect to the required speeds of the spindle.

FIG. 3 shows the grinding device 1 in a partially assembled state, the coupling element 14 of the drive device 10 not yet having been inserted into the recess of the partition element 21. The partition element 21, which is implemented as a lid, for example, is placed on the container 40, so that it terminates it. A part of the coupling device 31 protrudes out of the opening 23 of the recess 22.

FIG. 4 shows the grinding device 1 in the assembled state. The coupling element 14 of the spindle drive device 10 is inserted into the recess 22 of the partition unit 20. The part of the coupling device 31 protruding out of the recess 22 is engaged with the coupling opening 19 of the rotation transmission unit 18. More precisely, the part of the coupling device 31 protruding out of the recess 22 is inserted into the coupling opening 19 of the rotation transmission unit 18.

The assembly of the grinding device 1 is described hereafter. The work unit 30 is placed in a first step on to the mounting element 41 of the container 40, in order to fix the work unit 30 inside the container 40. Subsequently, the partition unit 20 is placed on the container 40 to terminate it. Alternatively, the partition unit 20 can be fixedly connected to the work unit 30, so that the container 40 is already terminated when the work unit 30 is placed on the mounting element 41. Furthermore, it is checked in a further step whether the shape of the coupling element 14 corresponds to the shape of the recess 22 of the partition element 21. If this is not the case, a corresponding coupling element 14 is removably connected to the housing 13 of the spindle drive device 10. Finally, the coupling element 14 of the spindle drive device 10 is placed in the recess 22, the part of the coupling device 31 protruding out of the opening 23 penetrating into the coupling opening 19 of the rotation transmission unit 18.

The operation of the grinding device 1 by a user is described hereafter. The user moves the actuating device 11, preferably manually, in the direction toward the coupling element 14. As a result of the movement of the rotationally-fixed actuating device 11, the rotationally-fixed spindle nut 15 also moves in the direction toward the coupling element 14. More precisely, the actuating device 11 first penetrates into the cavity of the housing 13 and then comes into contact with the spindle nut 15. Alternatively, it is conceivable that the actuating device 11 is already in contact with the spindle nut 15 in the non-actuated position.

The spindle 16 begins to rotate because of the contact of the spindle nut 15 with the thread of the spindle 16. The rotational movement of the spindle 16 is transmitted via the rotation transmission unit 18 to the coupling device 31 of the work unit 30. In this way, the work elements 32 located inside the container 40, such as grinding elements, are rotated. The spindle nut 15 is moved in the direction toward the coupling element 14 until the spindle nut 15 and/or the actuating device 11 strike against a stop element. It can be ensured by the spring 17 that the spindle nut 15 and actuating device 11 are displaced back into the starting location shown in FIG. 1, if the locking device is not actuated in order to prevent this.

### LIST OF REFERENCE NUMERALS

1 grinding device
10 drive device/spindle drive device
11 actuating device
13 housing
14 coupling element
15 rotation generation unit/spindle nut
16 spindle/drive unit
17 spring
18 rotation transmission unit
19 coupling opening
20 partition unit
21 partition element
22 recess
23 opening
30 work unit
31 coupling device
32 work element
40 container
41 mounting element

1. A drive device having an actuating device, a drive unit, which is drivable by the actuating device, and a rotation transmission unit, which is coupled to the drive unit, wherein a coupling device of a work unit can be engaged with the rotation transmission unit.

2. The drive device according to claim 1, wherein a partition unit is situated between the drive device and the work unit.

3. The drive device according to claim 2, wherein the drive device has a removably fastened coupling element on its end facing toward the partition unit.

4. The drive device according to claim 3, wherein the coupling element is insertable into a recess located in the partition unit.

5. The drive device according to claim 2, wherein the partition unit has a partition element having an opening, via which the coupling device is insertable into the rotation transmission unit.

6. The drive device according to claim 2, wherein the partition unit terminates a container and the drive device is situated outside and the work unit is situated inside the container.

7. The drive device according to claim 1, wherein the drive device is implemented as a spindle drive device for converting a longitudinal movement of the actuating device into a rotational movement of the rotation transmission unit.

8. The drive device according to claim 1, wherein at least one work element is drivable using the rotation transmission unit via the coupling device.

9. The drive device according to claim 8, wherein the work element is implemented as a striking element and/or grinding element and/or stirring element and/or spinning element and/or tool element.

10. The drive device according to claim 1, wherein the rotation transmission unit is implemented on the end of the drive unit remote from the actuating device.

11. The drive device according to claim 1, wherein the coupling device has a polygonal shape.

12. The drive device according to claim 1, wherein the rotation transmission unit has a coupling opening having a polygonal shape.

13. The drive device according to claim 2, wherein the rotation transmission unit is situated in the partition unit.

14. A method for driving a work unit using a drive device, which has the following steps:
inserting a coupling device of the work unit into a rotation transmission unit of the drive device and
actuating the drive device.

15. The method for driving a work unit according to claim 14, wherein a partition unit is attached to the drive device or the work unit before the coupling device is inserted into the rotation transmission unit.

16. The method for driving a work unit according to claim 14, wherein the work unit is placed on a mounting element before the coupling device is inserted into the coupling opening of the rotation transmission unit.
